(19) United States
(12) Patent Application Publication
(10) Pub. No.: US 2010/0301685 A1
(43) Pub. Date: Dec. 2, 2010

(54) LINEAR MACHINE

(75) Inventors: Andreas Grundl, Starnberg (DE); Bernhard Hoffmann, Starnberg (DE)

Correspondence Address: CARTER, DELUCA, FARRELL & SCHMIDT, LLP, 445 BROAD HOLLOW ROAD, SUITE 420, MELVILLE, NY, 11747, US

(73) Assignee: COMPACT DYNAMICS GMBH, Starnberg (DE)

(21) Appl. No.: 12/599,322

(22) PCT Filed: Apr. 29, 2008
(86) PCT No.: PCT/EP2008/003468

§ 371 Date: Jan. 6, 2010

(30) Foreign Application Priority Data
May 9, 2007 (DE) 10 2007 021 737.6

(51) Int. Cl. H02K 41/02

(52) U.S. Cl. 310/12.21

(57) ABSTRACT

Linear machine with a stator and a rotor, which are separated by an air gap and have at least one stator coil and/or one rotor coil respectively. The stator or rotor has a soft magnetic iron body with a stator back or rotor back, on which grooves are formed at a distance from each other, forming teeth. In the grooves, multiple conductor bars of the stator coil or rotor coil are arranged in rows. On the faces of the stator or rotor, end connectors which connect the conductor bars and extend over multiple grooves are present. Each conductor bar has a cavity on the face of at least one of its ends. Each end connector has an extension, which is arranged and dimensioned in such a way as to engage in an electrically conducting manner into the respective cavity of the conductor bar, on its section facing the respective front end of the conductor bars.

### SCOPE

A linear machine is described below. This is, for instance, a linear machine with a stator and a rotor, which have at least one stator coil and/or one rotor coil respectively, the stator or rotor having a soft magnetic iron body with a stator back or rotor back, on which grooves are formed at a distance from each other, forming teeth.

### DEFINITION OF TERMS

The term “linear machines”, i.e. asynchronous, synchronous, reluctance machines, permanently excited electrical machines, etc., is understood to mean both motors and generators, whether such a machine is in the form of a rotating machine or, for instance, a linear motor being insignificant. These linear machines can also be used in the case of both internal rotor machines and external rotor machines.

### BACKGROUND

In reducing the construction space of highly efficient electrical machines, the type and arrangement of the conductors of the field windings have an decisive role. The shortest possible conductor lengths in the winding overhangs and high exploitation of space reduce ohmic losses and increase the power density.

Since the ohmic losses in the driving circuit and in the (stator) winding are proportional to the current to be switched, a certain line length in the magnetic field must be provided, to generate an induced counter-voltage corresponding to the desired high driving voltage, with as low-resistance a conductor construction as possible.

Conventional electrical machines are mainly wound with continuous wires, mostly with a round cross-section. A thin, flexible wire can easily be put into the grooves, but a disadvantage is the low exploitation of space in the grooves and winding overhangs. Wires with a round conductor cross-section cannot fully exploit the cross-section area of the groove. Thus the space in the winding overhangs (i.e. the part of the winding which is not arranged in one of the axially running grooves) can also only be used insufficiently, and the magnetically ineffective line length, the total weight, the space requirement and the ohmic losses increase.

### PRIOR ART

From EP 1 039 616 A2, a linear machine, the stator of which carries a stator coil, is known. The stator has a soft magnetic iron body with a stator back, on which grooves are formed at a distance from each other, forming teeth. The stator coils each have a conductor bar arranged in the grooves, and end connectors which are arranged on the faces of the stator and connect the conductor bars. The conductor bars all have the same axial length. The end connectors of the stator coils are arranged in a position on the faces of the stator, transversely to the groove base. The end connectors are in the form of symmetrical parts, and project beyond the groove base alternately in the direction of the stator back and to the air gap of the linear machine. The end connectors and conductor bars are riveted to each other, a rivet being put through an opening in the end connector into a hole in the face of the conductor bar and riveted. This production method is very expensive.

From DE 101 43 217 A1, a linear machine with a stator and a rotor, which each have at least one stator coil or one rotor coil, is known. The stator or rotor has a soft magnetic iron body with a stator back or rotor back. On the back, grooves are formed at a distance from each other, forming teeth. The stators or rotor coils have conductor bars arranged in the grooves, and end connectors which are arranged on the faces of the stator or rotor and connect the conductor bars. The stators or rotor coils are angled transversely to the base of the grooves in the region of the end connectors, and project beyond the base of the grooves partly in the direction of the stator back or rotor back. A similar arrangement is shown in GB 1 281 691.

### PROBLEMS OF THE PRIOR ART

The known arrangements explained above have the disadvantage that they only partly fulfil the requirements for power density and reliability as set in some application fields. Also, assembling the end connectors with the conductor bars to form the coils is expensive.

The conformation of the coil ends is an essential factor for the efficiency of the electrical machine, the known conformations, in view of the requirements of mass production, not being optimised for highly efficient machines. Also, for instance, the design described in EP 1 039 616 A2 does not allow the use of multi-layer windings, since in this case the end connectors would collide with each other.

### SOLUTION

As a solution to these problems, a linear machine with a stator and a rotor, which are separated by an air gap and have at least one stator coil and/or one rotor coil respectively, is proposed. The stator or rotor has a soft magnetic iron body with a stator back or rotor back, on which grooves are formed at a distance from each other, forming teeth. In the grooves, multiple conductor bars of the stator coil or rotor coil are arranged in rows. On the faces of the stator or rotor, end connectors which connect the conductor bars and extend over multiple grooves are present. Each conductor bar has a cavity on the face of at least one of its ends. Each end connector has an extension, which is arranged and dimensioned in such a way as to engage in an electrically conducting manner into the respective cavity of the conductor bar, on its section facing the respective front end of the conductor bars. The extension is in the form of a mandrel, which in relation to the cavity is provided with an excess in the radial or lateral direction. It can thus be achieved that the extension is received in the cavity in an interference fit.

This conformation allows maximum exploitation of the existing space (in both the axial and the radial or lateral directions), with simultaneous optimisation of performance of the electrical machine, very high reliability in operation, and low production costs.

### Conformations and Further Developments of the Invention

The cavity can be in the form of a blind hole, with essentially round or polygonal cross-section. The cross-section of the cavity can change in the longitudinal direction of the conductor bar. The cavity can taper, or it can be provided with barbs (e.g. in the shape of a fir tree).

The extension can be formed with an essentially round or polygonal cross-section.

On the surface of the extension and/or of the cavity, a coating of brazing metal or solder can be at least partly arranged. The brazing metal or solder coating can be a brazing metal or solder material with a melting point above 200° C. The connection between the conductor bar and the end connector can also—irrespective of the structural form of the end section of the conductor bar and of the end section of the end connector—have a layer of brazing metal, preferably silver brazing metal, tin brazing metal or similar. Alternatively, the connection between the conductor bar and the end connector can have a layer of high temperature solder, preferably with a melting point of at least about 380° C.

The end connectors can be provided, at their two end regions, with transverse sections through which they are connected to the ends of the conductor bars (by means of the mandrel-like extensions and the oppositely formed cavities). The length of the transverse sections determines how far the winding overhangs reach over the backs of the rotor or stator, starting from the conductor bars.

The conductor bars can be formed to match at their ends with corresponding sections on the end connectors, for mechanical and electrical connection. The conformation of the mechanical and electrical connection can be implemented in different ways. As explained above, the connecting areas at the ends of the conductor bars or of the transverse sections of the end is connectors are formed by cavities, into which the corresponding sections (mandrels, journals, extensions) of the end connectors are joined. The electrical connection/contacting can be produced or at least improved by laser welding, pulsed current welding or resistance welding, and/or by melting on the solder coating(s).

The transverse sections at both end regions of the end connectors to the ends of the conductor bars can be of different lengths and/or angled at different angles.

Depending on whether the electrical machine Involves an internal rotor or an external rotor, the grooves can taper or widen towards the air gap between the stator and the rotor. In this way, the conductor bars arranged in the grooves, depending on their position in the groove, can have a width which is at least partly adapted to the groove width. This offers the maximum exploitation of the available groove space. The conductor bars can be provided with an essentially rectangular or trapezoidal cross-section, and a negative or positive approximately conical or approximately truncated-conical shape can be given to the cavities/extensions. However, it is also possible to use a triangular or polygonal pyramid shape or a triangular or polygonal truncated pyramid shape for the cavities/extensions. Instead of giving the cavities/extensions different transverse dimensions in their longitudinal direction (engagement direction), i.e. making their shape conical, pyramid-shaped or similar, the cavities/extensions can also have a cylindrical, e.g. circular cylindrical or oval, or prismatic shape. Thus in each case defined dimensions after assembly are achieved in the axial direction (i.e. their longitudinal direction).

Good exploitation of space can be achieved by arranging the end connectors, at least on one of the two faces of the stator, not only in the direction of the stator back, but also in the direction of the air gap between the stator and rotor. In this case, the length of the conductor bars increases both from the stator back and from the air gap between the stator and rotor to the centre of the winding chamber.

The conductor bars and/or the end connectors can be provided with a ceramic or enamel coating. In each case two of the parts (one conductor bar and one end connector) can be joined in an essentially L-shaped component, provided with a ceramic or enamel coating to before or after joining, and then inserted in layers (from both faces) into the grooves of the soft magnetic body and connected to the windings.

Other features, properties, advantages and possible modifications will become clear for a person skilled in the art on the basis of the description below, in which reference is made to the attached drawings.

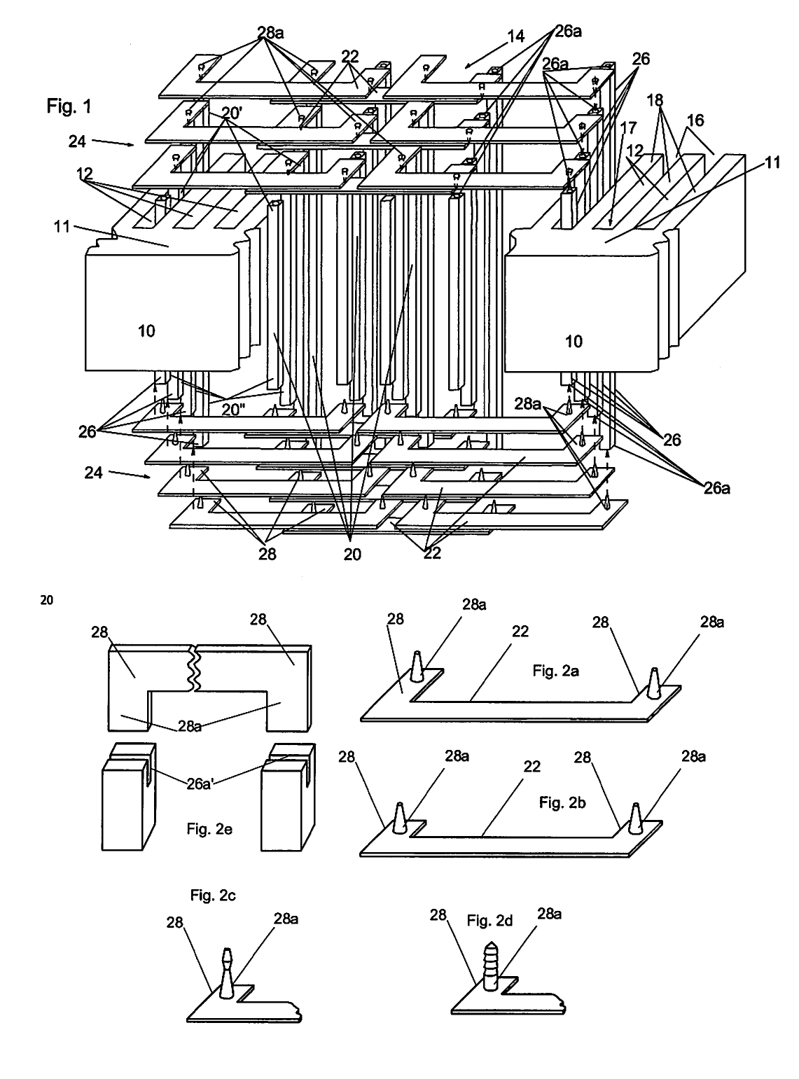

In FIG. 1, a schematic, perspective exploded view of a stator for an electrical machine is illustrated.

In FIGS. 2a, 2b, 2c, 2d and 2e, possible variants of the end connectors of the electrical machine according to FIG. 1 are illustrated in an enlarged representation.

### DETAILED DESCRIPTION OF PREFERRED EMBODIMENTS

In FIG. 1, two interrupted sections of a development of a stator 10 of a (not otherwise illustrated) internal rotor machine is shown in a plan view, the invention also being usable for an external rotor machine. In this embodiment, the stator 10 is built up of metal sheets (not otherwise illustrated) stacked one above the other, but it could also consist of iron particles which are pressed and sintered to the corresponding shape.

The stator 10, with a stator back 11, has grooves 12 which are arranged next to each other, and through which winding chambers for the corresponding stator coil windings 14 are formed. In the shown embodiment, the winding chambers 12 have an essentially rectangular cross-section, and they have slots 16 on their side facing the rotor (not shown). Between each two slots 16, a tooth 18 is formed.

Each stator coil 14 is formed of conductor bars 20 which are essentially rectangular in cross-section, and which are inserted into the winding chambers 12 and connected to the end connectors 22. The end connectors 22 of all windings together form winding overhangs 24 on both faces of the stator 10. For better clarity, some of the stator coils 14 are omitted, and the stator 10 is also shown in two sections, with an interruption.

The end connectors 22 are essentially oriented transversely to the base 17 of the grooves 16—relative to the longitudinal axis of the conductor bars 20—and project beyond the base 17 of the grooves 16, partly in the direction of the stator back 11. The end connectors 22 have to an essentially parallel orientation relative to the face of the stator 10 or rotor.

The end connectors 22 are connected, at one or both of their end regions, to the ends 26 of the conductor bars 20, through transverse sections 28 which are oriented transversely to the longitudinal axis of the conductor bars 20 (see also FIGS. 2a and 2b). The transverse sections can either be part of the end connector 22 as shown in FIG. 1, or part of the conductor bar 20.

As can be seen, in particular, in FIGS. 1 and 2a, the transverse sections 28 at the two end regions of the end connectors 22 to the ends 26 of the conductor bars 20 are of different lengths, to reach the relative position of the end connector 22 in the winding overhang 24.

The transverse sections 28 each have a mandrel 28a which is of truncated-conical shape and tapers conically at its free end. This mandrel 28a must be introduced into an essentially oppositely shaped cavity in the appropriate (in FIG. 1, top and bottom) end 26 of the conductor bars 20. The mandrel, more precisely the end connector 22, is thus electrically and mechanically connected to the appropriate conductor bar.

If the mandrel at least partly has an excess (e.g. 1%-10%) relative to the cavity, this increases the stability of the arrangement after assembly is completed.

To make the connection both electrically and mechanically safer, more low-resistance and stronger, at every mandrel and/or every cavity a deposit 50 of brazing metal or solder can be provided, in the form of a coating or body of brazing metal or solder or similar. This deposit 50 can be brought to melting by loading the conductor bar 20 and the end connector 22 connected to it with a high current, since in places with increased electrical resistance a local heat pocket occurs. This heat pocket brings the brazing metal or solder to melting, and thus reduces the electrical resistance. Additionally, a connection of brazing metal or solder increases the mechanical strength of the arrangement.

The dimensions are approximately chosen so that the cross-section at the foot of the mandrel (i.e. at the point at which the mandrel is formed on the end connector) is approximately 30%-100% of the cross-section of the end connector.

In FIG. 2a, one of the end connectors 22 which in FIG. 1 are arranged at the top end of the conductor bars 20 with transverse sections 28 of different lengths is illustrated.

In FIG. 2b, one of the end connectors 22 which in FIG. 1 are arranged at the bottom end of the conductor bars 20 with transverse sections 28 of the same length is illustrated.

In FIGS. 2c, 2d, alternative conformations of mandrels, which are to be inserted into correspondingly shaped cavities of the conductor bars, are shown.

In FIG. 2e, a further alternative conformation of the recess at the top end of the conductor bars 20 is shown, namely a laterally open slot 26a′ on the front end of the conductor bars 20. The slot 26a′ can also be implemented in laterally closed form. Into each slot 26a′, an essentially oppositely shaped extension 28a engages, and in the shown variant is at a distance from the end connector 22 in its prolongation. In the case of the other variants, the mandrel is at a distance laterally from the end connector.

The end connectors 22 extend—depending on the number of phases and the number of holes of the electrical machine—over multiple grooves 16. Conductor bars 20 which are arranged adjacently to each other in one groove have conductor sections 20′, 20″ which are of different lengths and project beyond the faces of the stator 10 or rotor. In the embodiment shown in FIG. 1, the length of the conductor sections 20′, 20″ increases from the stator back 11 to the free end of the teeth 18 (in other words to the air gap of the electrical machine). Correspondingly, the end connectors 22 are arranged in layers one above the other on the faces of the stator 10, growing in steps from the stator back 11 out to the teeth 18.

As also shown in FIG. 1, end connectors of one winding also overlap with end connectors of another winding in the lateral direction (e.g. from left to right in FIG. 1). The end connectors 22, with the two shortest conductor bars 20n (at the front in FIG. 1) of a winding 14, form the lowest layer, which is overlaid in steps by the end connectors of the next, second shortest conductor bars 20 of this winding 14 (at the back in FIG. 1). This construction is repeated as far as the longest conductor bars 20 (at the extreme back in FIG. 1) of this winding 14.

Between the end connectors 22 of a winding 14, the end connectors 22 of further windings 14 project in lateral steps.

The conductor bars, the length of which increases in steps, in each groove, and the end connectors of a winding, which overlap in steps in the longitudinal direction of the grooves, as well as the end connectors—which penetrate each other like scales in the transverse direction to the grooves—of adjacent windings, form a very compact, space-saving arrangement of the winding overhangs of the electrical machine.

The ratios shown in the figures of the individual parts and sections to each other, and their material thicknesses, are not to be understood restrictively. Instead, individual dimensions can differ from those shown. It is also understood that for rotating machines, i.e. internal or external rotor machines, the embodiments shown in the figures must be arranged or curved correspondingly around an axis of rotation.

1. Linear machine comprising
a stator; and
a rotor, the stator and the rotor separated by an air gap and have at least one stator coil and/or one rotor coil respectively, wherein the stator or rotor has a soft magnetic iron body with a stator back or rotor back, on which grooves are formed at a distance from each other, forming teeth, and in the grooves, multiple conductor bars of the stator coil or rotor coil are arranged in rows, and have, on the faces of the stator or rotor, end connectors which connect the conductor bars and extend over multiple grooves, and wherein each conductor bar has a cavity on the face of at least one of its ends, each end connector has an extension, which is arranged and dimensioned in such a way as to engage in an electrically conducting manner into the respective cavity of the conductor bar, on its section facing the respective front end of the conductor bars, and wherein the extension is in the form of a mandrel, which in relation to the cavity is provided with an excess in the radial or lateral direction.

2. Linear machine according to claim 1, wherein the cavity is in the form of a blind hole, with essentially round or polygonal cross-section.

3. Linear machine according to claim 1, wherein the mandrel is formed with an essentially round or polygonal cross-section.

4. Linear machine according to claim 1, wherein the extension is received in the cavity in an interference fit.

5. Linear machine according to claim 1, wherein a coating of brazing metal or solder is at least partly arranged on the extension.

6. Linear machine according to claim 1, wherein a coating of brazing metal or solder is at least partly arranged in the cavity.

7. Linear machine according to claim 5, wherein the coating of brazing metal or solder is a brazing metal or solder material with a melting point above 200° C.

8. Linear machine according to claim 1, wherein in each of the grooves, conductor bars which are arranged adjacently to each other have conductor sections which are of different lengths and project beyond the faces of the stator or rotor, and the end connectors are arranged at least partly in stepped layers in the axial direction on the faces of the stator or rotor.

9. Linear machine according to claim 1, wherein the end connectors have an essentially rectangular cross-section, each extension being at a distance from the end connector laterally or in its prolongation.

10. Linear machine according to claim 1, wherein the end connectors are connected at their two end regions to the ends of the conductor bars by transverse sections.

11. Linear machine according to claim 1, wherein the transverse sections at both end regions of the end connectors to the ends of the conductor bars are of different lengths and/or angled at different angles.

12. Linear machine according to claim 1, wherein the conductor bars each have at their ends a connecting area, which fits together with corresponding sections on the end connectors for mechanical and electrical connection.

13. Linear machine according to claim 1, wherein the connecting areas at the ends of the conductor bars are joined and/or welded or brazed or soldered to correspondingly shaped extensions of the transverse sections.

14. Linear machine according to claim 1, wherein the end sections of the end connectors are joined coalescently by laser welding to the end sections of the conductor bar.

15. Linear machine according to claim 1, wherein the grooves taper or widen towards an air gap between the stator and rotor, and the conductor bars arranged in the grooves, depending on their position in the groove, have a width which is at least partly adapted to the groove width.

16. Linear machine according to claim 1, wherein the end connectors, at least on one of the two faces of the stator, are arranged in the direction of the stator back and in the direction of the air gap between the stator and rotor, the length of the conductor bars increasing both from the stator back and from the air gap between the stator and rotor to the centre of the grooves.

17. Linear machine according to claim 1, wherein the cavity is in the form of a laterally open or laterally closed slot.
